(19) United States
(12) Patent Application Publication
(10) Pub. No.: US 2014/0058727 A1
(43) Pub. Date: Feb. 27, 2014

(54) MULTIMEDIA RECORDING SYSTEM AND METHOD

(71) Applicants: TAI-MING GOU, Tu-Cheng (TW); YI-WEN CAI, Tu-Cheng (TW); CHUN-MING CHEN, Tu-Cheng (TW)

(72) Inventors: TAI-MING GOU, Tu-Cheng (TW); YI-WEN CAI, Tu-Cheng (TW); CHUN-MING CHEN, Tu-Cheng (TW)

(73) Assignee: HON HAI PRECISION INDUSTRY CO., LTD., Tu-Cheng (TW)

(21) Appl. No.: 13/596,138

(22) Filed: Aug. 28, 2012

(30) Foreign Application Priority Data
Aug. 21, 2012 (TW) 101130202

(51) Int. Cl. G10L 15/26

(52) U.S. Cl. 704/235; 704/E15.043

(57) ABSTRACT

A multimedia recording system is provided. The multimedia recording system includes a storage module, a recognition module, and a tagging module. The storage module stores a multimedia file corresponding to multimedia data with audio content, wherein the multimedia data is received through a computer network. The recognition module converts the audio content of the multimedia data into text. The tagging module produces tag information according to the text, wherein the tag information corresponds to portion(s) of the multimedia file. The disclosure further provides a multimedia recording method.

### BACKGROUND

1. Technical Field

The present disclosure relates to a multimedia recording system, and particularly to a multimedia recording system which is capable of translating spoken words into text and tagging a multimedia file corresponding to the spoken words according to the text.

2. Description of Related Art

Meeting minutes are generally made by manually translating the spoken words of the participators into text in a paper file or an electronic file. However, errors such as wrong comprehension are liable to happen when manually translating the spoken words, while text-only files are disadvantageous to a person in understanding the content of a meeting. In addition, although multimedia items such as audio/video recordings can present the content of a meeting in an intuitive manner, topics in each multimedia item cannot be located by a user without a search.

Thus, there is room for improvement in the art.

### BRIEF DESCRIPTION OF THE DRAWINGS

Many aspects of the present disclosure can be better understood with reference to the drawings. The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of a multimedia recording system of the present disclosure.

FIG. 2 is a schematic diagram of editing a multimedia meeting minute through an editing interface provided by the multimedia recording system shown in FIG. 1.

FIG. 3 is a schematic diagram of displaying a multimedia meeting minute through a display interface provided by the multimedia recording system shown in FIG. 1.

FIG. 4 is a flowchart of an embodiment of a multimedia recording method implemented through the multimedia recording system shown in FIG. 1.

FIG. 5 is a flowchart of an embodiment of step S1130 of FIG. 4 implemented through the multimedia recording system shown in FIG. 1.

### DETAILED DESCRIPTION

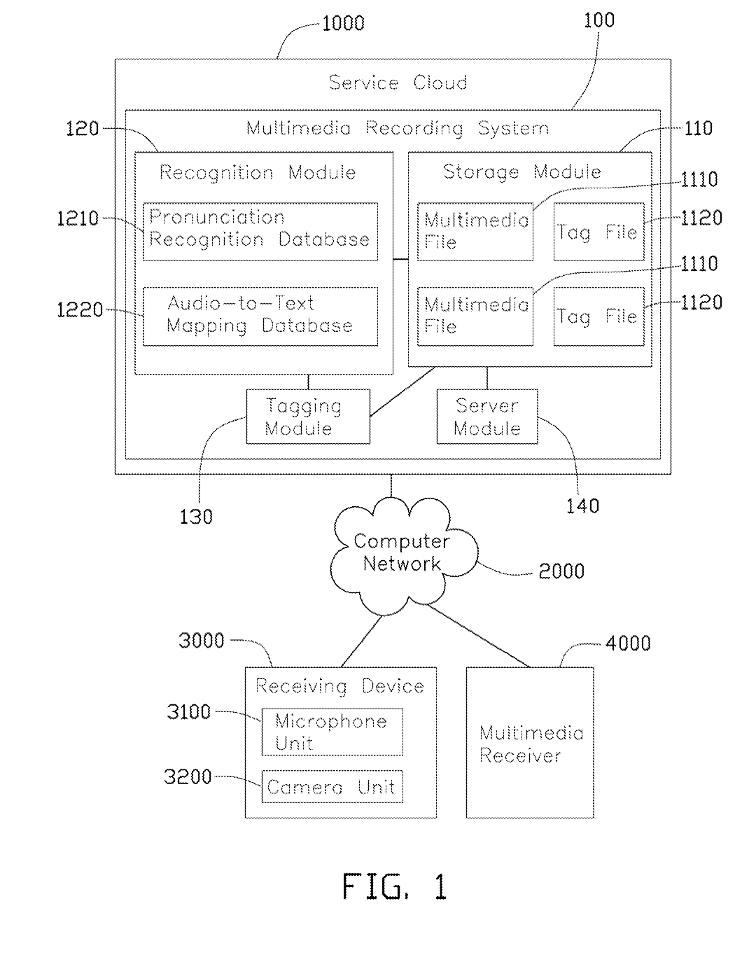

FIG. 1 is a block diagram of an embodiment of a multimedia recording system 100 of the present disclosure. In the illustrated embodiment, the multimedia recording system 100 is installed in a service cloud 1000 which includes one or more servers, and is applied to produce computer file(s) with respect to a multimedia meeting minute. In other embodiments, the multimedia recording system 100 can be installed in other types of computer systems such as personal computers, and can be applied to produce other types of multimedia items such as audio/video recordings. The multimedia recording system 100 includes a storage module 110, a recognition module 120, a tagging module 130, and a server module 140. In the illustrated embodiment, the multimedia recording system 100 receives multimedia data stream(s) including multimedia data D (not shown) through a computer network 2000, wherein the computer network 2000 may include a wired network such as Ethernet network and/or a wireless network such as WI-FI network. The multimedia data D is produced by a receiving device 3000 such as a video camera including a microphone unit 3100 and a camera unit 3200, which includes audio content produced by the microphone unit 3100 and video content produced by the camera unit 3200. In other embodiments, the multimedia recording system 100 can receive computer file(s) including the multimedia data D. In addition, the multimedia data D can merely include audio content, wherein the multimedia data D can be produced by the receiving device 3000 or other devices merely producing the audio content of the multimedia data D.

The storage module 110 includes a device such as a random access memory, a non-volatile memory, or a hard disk drive for storing and retrieving digital information, which stores the received multimedia data D as a multimedia file 1110. The recognition module 120 converts the audio content of the multimedia file 1110 corresponding to the audio content of the multimedia data D into text. When the multimedia file 1110 includes the video content, the recognition module 120 may reference the video content when converting, thereby ensuring the correctness or enhancing the accuracy of the conversion. For instance, the recognition module 120 can detect the movements of the lips of a speaker through the video content with respect to the speaker, determine the pronunciations corresponding to the movements, and reference the pronunciations when converting the audio content into the text, thereby complementing the inadequacy in receiving sounds. In addition, the recognition module 120 can determine the identity or the mood of a speaker through the video content with respect to the speaker, thereby describing the identity or the mood of the speaker in the text. The recognition module 120 may also reference text content of a document file when converting. For instance, the multimedia recording system 100 can input meeting materials such as presentation documents, such that the recognition module 120 can use the phrase(s) in the text content of the meeting materials as the key words for converting the audio content into the text, thereby enhancing the correctness of the conversion.

In the illustrated embodiment, the recognition module 120 includes a pronunciation recognition database 1210 and an audio-to-text mapping database 1220. The pronunciation recognition database 1210 stores pronunciation recognition principles. The audio-to-text mapping database 1220 stores audio-to-text mapping data. The recognition module 120 converts the audio content of the multimedia data D into waveform signal(s), identifies sound portion(s) such as vowels and consonants by analyzing the waveform signal(s) according to the pronunciation recognition principles in the pronunciation recognition database 1210, produces pronunciation data according to the sound portion(s), and produces the text by comparing the pronunciation data with the audio-to-text mapping data in the audio-to-text mapping database 1220.

Table 1, below, shows an embodiment of tag information I produced by the tagging module 130 shown in FIG. 1. In the illustrated embodiment, the tagging module 130 produces the tag information I according to the text and a predetermined topic list. The predetermined topic list is stored in the storage module 110, which includes predetermined topic(s) defined in advance by, for instance, using a voice recognition condition interface which is a computer software executed by the service cloud 1000. The tagging module 130 produces the tag information I including topic(s) each corresponding to one of the predetermined topic(s) in the predetermined topic list, wherein each of the topic(s) corresponds to a beginning of a portion of the multimedia file 1110 with respect to the topic. For instance, each of the topics can have a name field including the name of the topic and a timing field including the timing of the beginning of the portion of the multimedia file 1110 with respect to the topic.

TABLE 1
Tag Information I

| Topic 1 | | Topic 2 | | | |
|---|---|---|---|---|---|
| | First | | Second | Topic 3 | |
| Name | Sub-Subject | Name | Sub-Subject | Name | Conclusion |
| Timing | 00:02:10 | Timing | 00:032:50 | Timing | 01:01:20 |

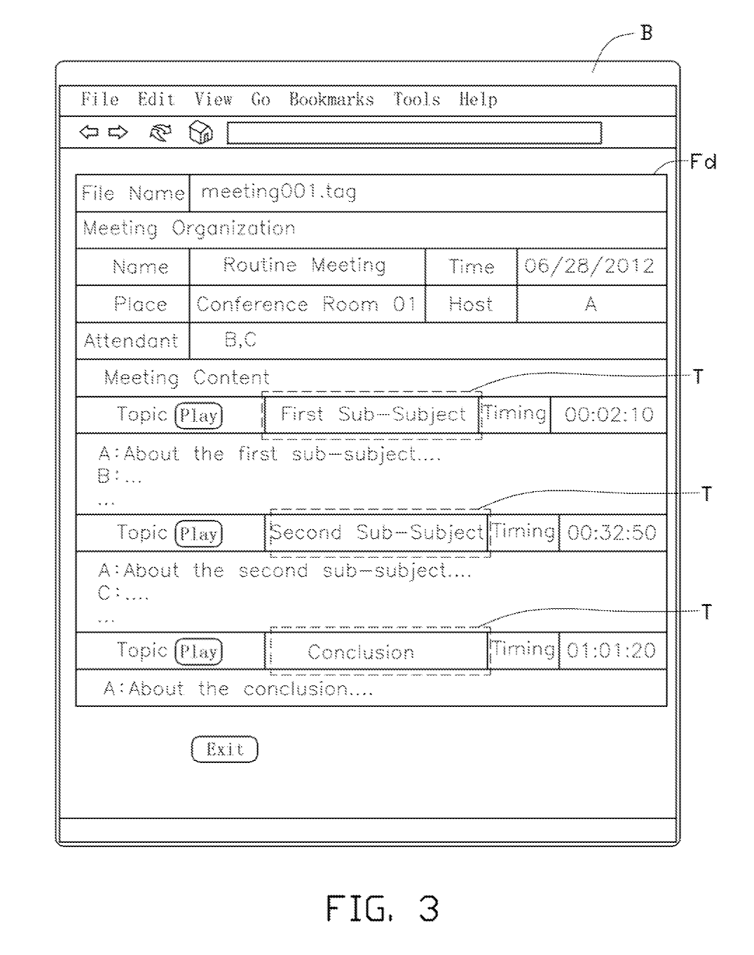

The multimedia recording system 100 may be selectively operated in different scenarios. For instance, in a meeting scenario, the storage module 110 stores related information of a meeting, for example, the organization and the content (including the text, see FIG. 3) of the meeting, as a tag file 1120 according to the tag information I, wherein each tag file 1120 corresponds to one multimedia file 1110. In a documentary scenario, the storage module 110 stores related information of a audio/video recording, for example, the subject and the content of the audio/video recording, as the tag file 1120 according to the tag information I. In a business scenario, the storage module 110 stores related information of a deal, for example, the name and the content of the deal, as the tag file 1120 according to the tag information I. After the tag file 1120 is created, persons who relates to the content of the tag file 1120 can be informed by, for instance, sending a message such as an e-mail which includes the information about the tag file 1120 to the corresponding persons. For instance, the message can be automatically sent according to a list of receiver(s) defined in advance. In other embodiments, the related information can be integrated with the multimedia file 1110 according to the tag information I.

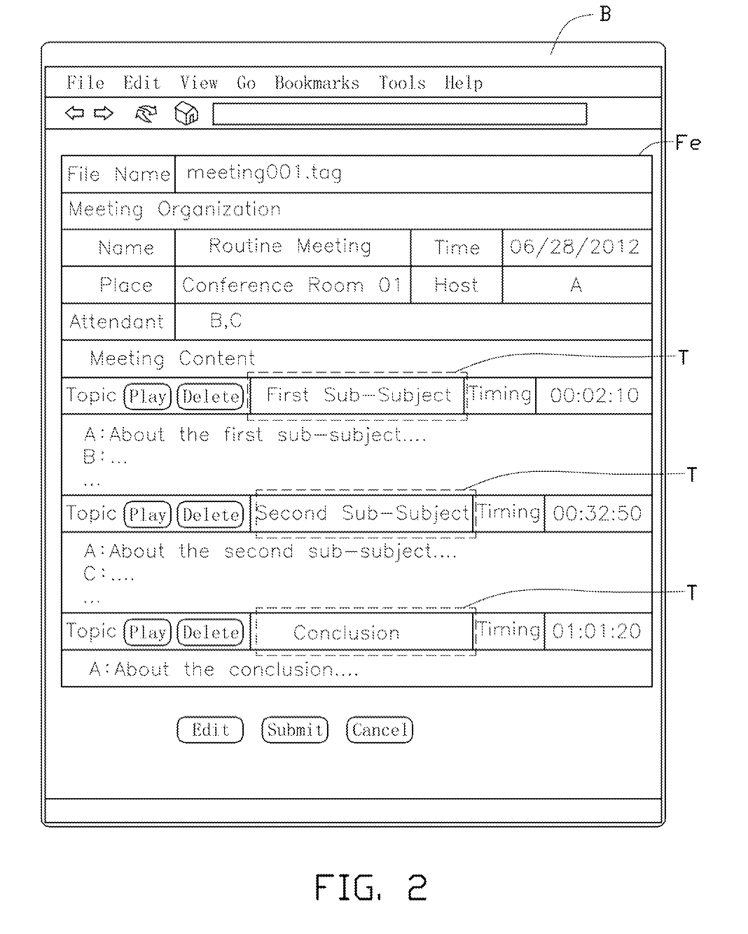

FIG. 2 is a schematic diagram of editing a multimedia meeting minute through an editing interface Fe provided by the multimedia recording system 100 shown in FIG. 1. FIG. 3 is a schematic diagram of displaying a multimedia meeting minute through a display interface Fd provided by the multimedia recording system 100 shown in FIG. 1. In the illustrated embodiment, the server module 140 provides a network service such as a web service through the computer network 2000, wherein the network service is capable of providing the editing interface Fe and the display interface Fd. The editing interface Fe and the display interface Fd are displayed as a web page through a web browser B which is a computer software executed by the service cloud 1000 or a multimedia receiver 4000, wherein the multimedia receiver 4000 is an electronic device such as a computer or a portable device. The editing interface Fe is for editing the contents of the tag file 1120. The display interface Fd is for displaying the contents of the multimedia file 1110 and the tag file 1120, which includes tags T corresponding to the topics of the tag information I. Each of the tags T can be selected by, for instance, clicking a button adjacent to the tag, to view a content corresponding to a portion of the multimedia file 1110 with respect to the corresponding topic. When the multimedia file 1110 includes the video content, the text stored in the tag file 1120 can be used as the subtitle of the video content. In other embodiments, the editing interface Fe and the display interface Fd can be provided through other types of computer software executed by the service cloud 1000 or the multimedia receiver 4000 such as an application software.

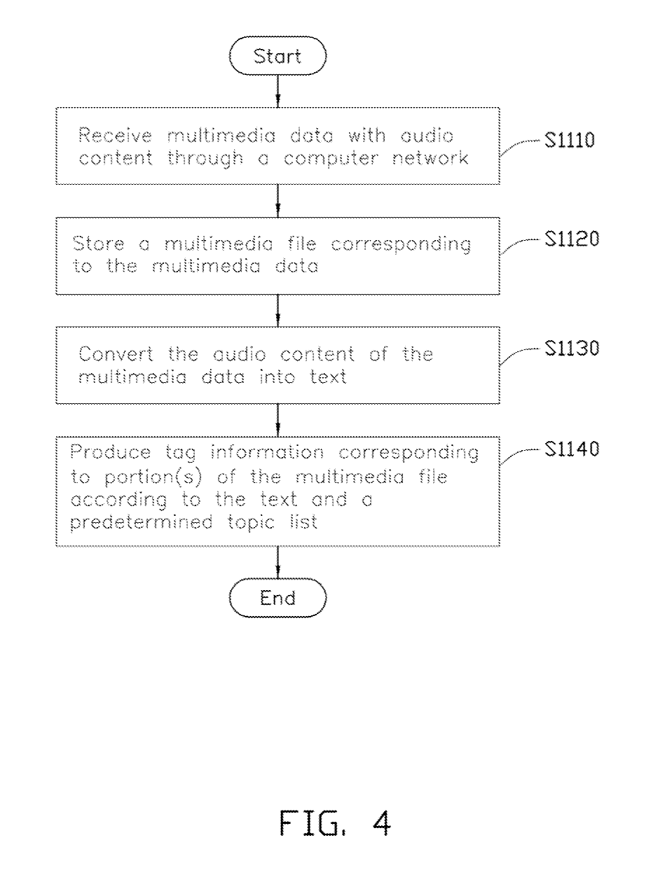

FIG. 4 is a flowchart of an embodiment of a multimedia recording method implemented through the multimedia recording system shown in FIG. 1. The multimedia recording method of the present disclosure follows. Depending on the embodiment, additional steps may be added, others removed, and the ordering of the steps may be changed.

In step S1110, the multimedia data D with audio content is received through the computer network 2000. In the illustrated embodiment, the multimedia data D includes audio content and video content.

In step S1120, the multimedia file 1110 corresponding to the multimedia data D is stored.

In step S1130, the audio content of the multimedia file 1110 corresponding to the audio content of the multimedia data D is converted into the text. In the illustrated embodiment, the video content of the multimedia data D can be referenced while being converted. In addition, a document file can be referenced while being converted.

In step S1140, the tag information I corresponding to portion(s) of the multimedia file 1110 is produced according to the text and the predetermined topic list. The tag information I includes topic(s) corresponding to the predetermined topic list, wherein each of the topics corresponds to a beginning of a portion of the multimedia file 1110 corresponding to the topic. In the illustrated embodiment, the tag file 1120 corresponding to the multimedia file 1110 is created according to the tag information I. In other embodiments, the related information can be integrated with the multimedia file 1110 according to the tag information I.

In the illustrated embodiment, a network service such as a web service is provided through the computer network 2000, wherein the network service is capable of providing the editing interface Fe (see FIG. 2) and the display interface Fd (see FIG. 3). The editing interface Fe is for editing the contents of the tag file 1120. The display interface Fd is for displaying the contents of the multimedia file 1110 and the tag file 1120, which includes the tags T corresponding to the topics of the tag information I. Each of the tags T can be selected to view a content corresponding to a portion of the multimedia file 1110 with respect to the corresponding topic.

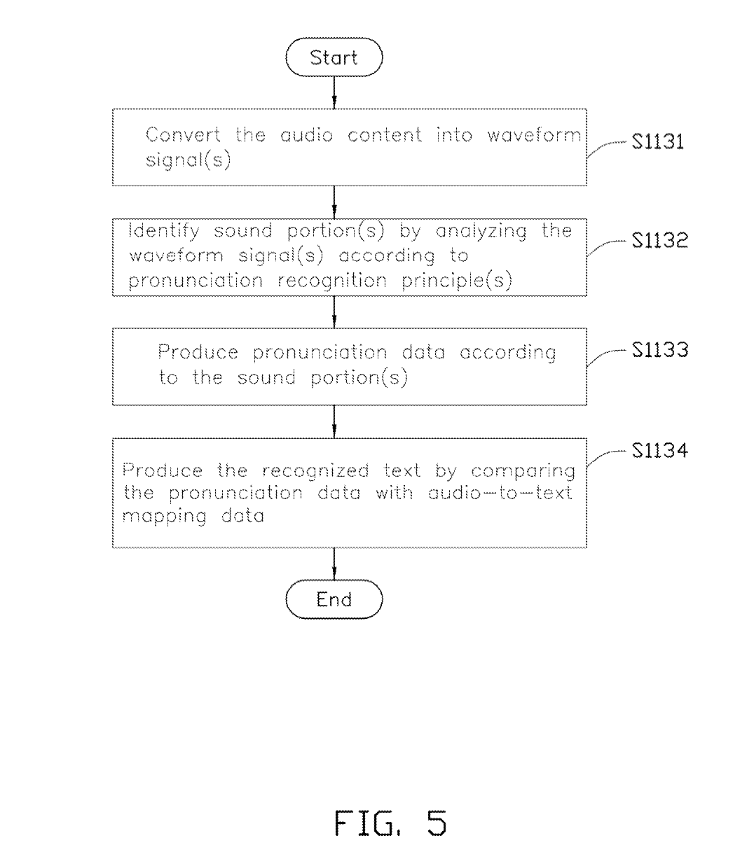

FIG. 5 is a flowchart of an embodiment of step S1130 of FIG. 4 implemented through the multimedia recording system 100 shown in FIG. 1.

In step S1131, the audio content of the multimedia data D is converted into waveform signal(s).

In step S1132, sound portion(s) such as vowels and consonants are identified by analyzing the waveform signal(s) according to pronunciation recognition principles.

In step S1133, pronunciation data is produced according to the sound portion(s).

In step S1134, the text is produced by comparing the pronunciation data with audio-to-text mapping data.

The multimedia recording system and the multimedia recording method are capable of translating spoken words into text and tagging a multimedia file corresponding to the spoken words according to the text, thereby producing computer files with respect to multimedia items such as multimedia meeting minutes or audio/video recordings, which allows a user to locate a topic in each multimedia item.

While the disclosure has been described by way of example and in terms of preferred embodiment, the disclosure is not limited thereto. On the contrary, it is intended to cover various modifications and similar arrangements as would be apparent to those skilled in the art. Therefore the range of the appended claims should be accorded the broadest interpretation so as to encompass all such modifications and similar arrangements.

What is claimed is:

1. A multimedia recording system, comprising:
a storage module storing a multimedia file corresponding to multimedia data with audio content, wherein the multimedia data is received through a computer network;
a recognition module converting the audio content of the multimedia data into text; and
a tagging module producing tag information according to the text, wherein the tag information corresponds to one or more portions of the multimedia file.

2. The multimedia recording system of claim 1, wherein the tagging module produces the tag information according to the text and a predetermined topic list.

3. The multimedia recording system of claim 2, wherein the tagging module produces the tag information comprising one or more topics corresponding to the predetermined topic list, each of the one or more topics corresponds to a beginning of a portion of the multimedia file corresponding to the topic.

4. The multimedia recording system of claim 1, wherein the tag information comprises one or more topics, each of the one or more topics corresponds to a beginning of a portion of the multimedia file corresponding to the topic.

5. The multimedia recording system of claim 1, further comprising a server module providing an editing interface for the tag information through the computer network.

6. The multimedia recording system of claim 1, further comprising a server module providing a display interface comprising one or more tags corresponding to the tag information through the computer network, wherein the one or more tags can be selected to view a content corresponding to the one or more portions of the multimedia file.

7. The multimedia recording system of claim 1, wherein the storage module creates a tag file corresponding to the multimedia file according to the tag information.

8. The multimedia recording system of claim 1, wherein the multimedia data comprises video content, the recognition module references the video content when converting the audio content of the multimedia data into the text.

9. The multimedia recording system of claim 1, wherein the recognition module converts the audio content of the multimedia data into the text according to text content of a document file.

10. The multimedia recording system of claim 1, wherein the recognition module comprises a pronunciation recognition database storing pronunciation recognition principles and an audio-to-text mapping database storing audio-to-text mapping data, the recognition module converts the audio content into one or more waveform signals, analyzes the one or more waveform signals according to the pronunciation recognition principles in the pronunciation recognition database to identify one or more sound portions, produces pronunciation data according to the one or more sound portions, and compares the pronunciation data with the audio-to-text mapping data in the audio-to-text mapping database to produce the text.

11. A multimedia recording method, comprising:
receiving multimedia data with audio content through a computer network;
storing a multimedia file corresponding to the multimedia data;
converting the audio content of the multimedia data into text; and
producing tag information corresponding to one or more portions of the multimedia file according to the text.

12. The multimedia recording method of claim 11, wherein the step of producing the tag information comprises:
producing the tag information corresponding to the one or more portions of the multimedia file according to the text and a predetermined topic list.

13. The multimedia recording method of claim 12, wherein the step of producing the tag information comprises:
producing the tag information comprising one or more topics corresponding to the predetermined topic list, each of the one or more topics corresponds to a beginning of a portion of the multimedia file corresponding to the topic.

14. The multimedia recording method of claim 11, wherein the step of producing the tag information comprises:
producing the tag information comprising one or more topics, each of the one or more topics corresponds to a beginning of a portion of the multimedia file corresponding to the topic.

15. The multimedia recording method of claim 11, further comprising:
providing an editing interface for the tag information through the computer network.

16. The multimedia recording method of claim 11, further comprising:
providing a display interface comprising one or more tags corresponding to the tag information through the computer network, wherein the one or more tags can be selected to view a content corresponding to the one or more portions of the multimedia file.

17. The multimedia recording method of claim 11, further comprising:
creating a tag file corresponding to the multimedia file according to the tag information.

18. The multimedia recording method of claim 11, wherein the step of receiving the multimedia data comprises:
receiving the multimedia data with the audio content and video content through the computer network;
the step of converting the audio content comprises:
converting the audio content of the multimedia data into the text by referencing the video content.

19. The multimedia recording method of claim 11, wherein the step of converting the audio content comprises:
converting the audio content of the multimedia data into the text according to text content of a document file.

20. The multimedia recording method of claim 11, wherein the step of converting the audio content comprises:
converting the audio content into one or more waveform signals;
identifying one or more sound portions by analyzing the one or more waveform signals according to one or more pronunciation recognition principles;
producing pronunciation data according to the one or more sound portions; and
producing the text by comparing the pronunciation data with one or more audio-to-text mapping data.
